(19) United States
(12) Patent Application Publication
(10) Pub. No.: US 2009/0071804 A1
(43) Pub. Date: Mar. 19, 2009

(54) Switching Device Lock Out Method and Apparatus

(75) Inventors: Dennis M. Drake, Cudahy, WI (US); Jon L. Phillips, Brookfield, WI (US)

Correspondence Address: Fletcher Yoder Law;(for Rockwell Automation), P. O. Box 692289, Houston, TX, 77269-2289, US

(73) Assignee: ROCKWELL AUTOMATION TECHNOLOGIES, INC., Mayfield Heights, OH (US)

(21) Appl. No.: 11/856,592

(22) Filed: Sep. 17, 2007

(51) Int. Cl. H01H 9/28

(52) U.S. Cl. 200/43.14

(57) ABSTRACT

A system, in certain embodiments, may include a circuit breaker having a housing, a toggle switch coupled to the housing, and an integral lock out coupled to the housing. The integral lock out may include a slide configured to move in a linear direction between a retracted position and an extracted position relative to the housing. The slide may be configured to block rotation of the toggle switch in the extracted position of the slide.

### BACKGROUND

The invention relates generally to the field of electrical circuit breakers and, more specifically, to a lock out feature to block unauthorized activation of a circuit breaker.

In order to protect downstream devices (e.g., loads) in electrical systems from excessive and/or undesirable power levels, electrical pathways coupling the device to the power source are traditionally interrupted before the undesirable power reaches the device. Typically, a protection or interruption device, such as a circuit breaker or a fuse, accomplishes this interruption. The circuit breaker may also act as a safe and accessible interface to remove power from the downstream devices prior to adjustment, maintenance, or repair. In general, it is desirable to add a lock out mechanism to circuit breakers. Unfortunately, in small form factor circuit breakers, such as miniature circuit breakers (MCB's), it is particularly challenging to incorporate lock out mechanisms due to space constraints. If the circuit breakers are positioned in close proximity with one another, then it is even more challenging to incorporate lock out mechanisms.

### BRIEF DESCRIPTION

In accordance with an exemplary embodiment of the present technique, a system is provided that includes a circuit breaker. The circuit breaker includes a housing, a toggle switch coupled to the housing, and an integral lock out coupled to the housing The integral lock out includes a slide configured to move in a linear direction between a retracted position and an extracted position relative to the housing and configured to block rotation of the toggle switch in the extracted position of the slide

In accordance with another exemplary embodiment, a system is provided that includes a lock out. The lock out includes a pin configured to couple to an actuator of an electrical device and a slide configured to move in a linear direction between a retracted position and an extracted position relative to the electrical device. The slide is configured to engage the pin in the extracted position of the slide.

Finally, in certain embodiments, a method is provided that includes blocking rotation of a toggle switch in response to a linear movement of a slide from a retracted position to an extracted position relative to an electrical device having the toggle switch. The method also may include receiving a lock into a receptacle of the slide to retain the slide in the extracted position to lock out the toggle switch.

### DRAWINGS

These and other features, aspects, and advantages of the present invention will become better understood when the following detailed description is read with reference to the accompanying drawings in which like characters represent like parts throughout the drawings, wherein:

FIG. 1 is a side view of an embodiment of a circuit breaker with an exemplary lock out feature;

FIG. 2. is a front view of an embodiment of the circuit breaker and exemplary lock out feature of FIG. 1;

FIG. 3 is a side view of an embodiment of the circuit breaker and exemplary lock out feature of FIG. 1, illustrating the slide of the lock out feature in a partially extracted position and engaging a toggle handle of the circuit breaker;

FIG. 4 is a side view of an embodiment of the circuit breaker and exemplary lock out feature of FIG. 1, illustrating the slide of the lock out feature in a fully extracted position and engaging the toggle handle of the circuit breaker;

FIG. 5 is a perspective view of an embodiment of the circuit breaker and exemplary lock out feature of FIG. 1, illustrating a padlock attached to the lock out feature; and

FIG. 6 is a perspective view of an embodiment of a system having a row of adjacent circuit breakers, each having an exemplary lock out feature with an attached padlock.

### DETAILED DESCRIPTION

As discussed in detail below, embodiments of the present technique provide an apparatus and method for a permanent lock out of a circuit breaker. Although the following discussion focuses on a specific type of circuit breaker, e.g., a miniature circuit breaker (MCB), the present technique may provide benefits to any type of circuit breakers or other electrical devices. Indeed, the following discussion merely provides exemplary embodiments, and these examples are not intended to limit the scope of the appended claims. Furthermore, as will be appreciated by those of ordinary skill in the art in view of the present discussion, the exemplary circuit breaker and permanent lock out feature is subject to various adaptations for incorporation into applications with a wide variety of devices.

The disclosed embodiments include a permanent lock out feature for a protection or interruption device, such as a circuit breaker. Conventional lock out features are typically removable (i.e., not permanently attached), thereby allowing a user to circumvent the lock out feature. The lock out feature described herein may be set in a variety of positions to engage the toggle handle of the circuit breaker and receive a padlock, or to completely disengage the toggle handle of the circuit breaker and allow free movement of the toggle handle. Further, the exemplary lock out feature described herein is configured to operate in close proximity with other lock out features, e.g., a row of adjacent circuit breakers mounted to a plate or rail, in which each individual circuit breaker may have a lock out feature permanently attached. Each lock out feature in the row of adjacent circuit breakers may be set in a different position to lock or unlock the toggle handle of any circuit breaker.

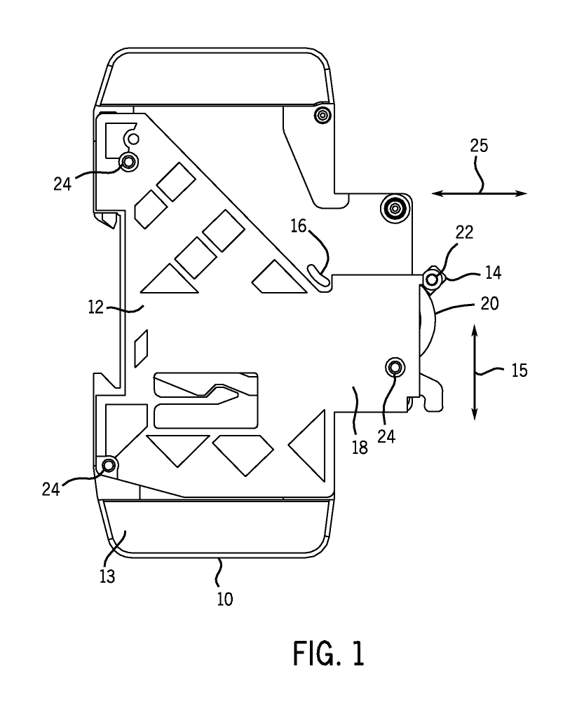

Turning now to the figures, FIG. 1 depicts a side view of a circuit breaker 10 with an exemplary permanent lock out feature 12. The circuit breaker 10 may have a specific rating and size, for example, a MCB having a rating of less than 100 Amps. The circuit breaker 10 has an outer housing 13 in which the functional components of the circuit breaker are disposed. The illustrated outer housing 13 contains an interrupt assembly configured to interrupt the current carrying path through the device. The interrupt assembly and the circuit breaker 10 may interrupt, isolate, or bridge a circuit or system having any number of electrical components or devices, such as a motor, actuator, or other device. Further, the circuit breaker 10 may be part of a system, such as a computer system, a network, an automation system, an industrial system, or any other electrical system in which an interrupt or isolation device is used. The illustrated housing 13 is formed of an electrically insulative material to protect the components of the circuit breaker 10 and to protect the environment from electrical events within the circuit breaker 10.

A toggle handle 14 is used to change the operating state of the circuit breaker 10. As depicted in FIG. 1, the toggle handle 14 is in an upward or OFF position, in which the circuit breaker 10 interrupts the circuit or system to which it is attached. In the upward or OFF position, any electrical circuits or devices on the same circuit as the circuit breaker 10 are isolated from any power source connected through circuit breaker 10. The illustrated toggle handle 14 is configured to pivot in a longitudinal direction 15 between the upward or OFF position (as shown) and a downward or ON position. As discussed above, it may be desirable to lock the toggle handle 14 in the upward or OFF position using the exemplary lock out feature 12.

The circuit breaker 10 also includes a vent 16 that may relieve pressure or heat from inside the circuit breaker 10. For example, if the circuit breaker 10 is activated, such as by an over current condition, then the vent 16 may enable sparks, flames, or hot gas to expel from the circuit breaker 10. The vent 16 provides a way to dissipate this energy and reduce the possibility of damage to the internal components of the circuit breaker 10. Thus, in some configurations, the circuit breaker 10 may be installed such that the vent 16 is not covered or blocked by any adjacent structures or components.

The lock out feature 12 may be permanently coupled to the circuit breaker 10. The lock out feature 12 includes a body 18, a slide 20, and a separate pin 22 that inserts into a hole on the toggle handle 14. The body 18 houses the slide 20 and may have the same profile as the circuit breaker 10. When coupled to the circuit breaker 10, therefore, only the slide 20 of the lock out feature 12 may protrude from the profile of the circuit breaker 10, enabling the lock out feature 12 to be easily integrated into the installation location of the circuit breaker 10. The lock out feature 12 is coupled to the circuit breaker 10 by three screws 24 located at the periphery of the body 18 of the lock out feature 12. The three screws 24 are driven into the housing 13 of the circuit breaker 10. The three screws 24 may permanently couple the lock out feature 12 to the circuit breaker 10, thereby reducing the possibility of inadvertent or unauthorized removal and operation of circuit breaker 10.

The body 18 may be designed so that the vent 16 is uncovered and open, thus enabling the vent 16 to relieve pressure and heat as discussed above. Alternatively, the body 18 may cover the vent 16 if it is determined that the functionality of the vent is not needed or is not impaired. For example, in some embodiments the body 18 may completely cover the side of the housing 13, but may have a hole exposing the vent 16. If the vent 16 is uncovered, the body 18 of the lock out feature 12 may be designed in any manner that enables the vent 16 to be open.

As illustrated in FIG. 1, the slide 20 is shown in a fully retracted position. In other words, the illustrated slide 20 is shown withdrawn into the body 18, such that the slide 20 is substantially flush with a face of the circuit breaker 10. In this retracted position, the slide 20 does not engage the pin 22 inserted into the toggle handle 14, and therefore cannot interfere with movement of the toggle handle 14 between the ON or OFF positions. As will be described further below, the slide 20 may be moved in a linear direction indicated by line 25 and extracted from or retracted into the body 18 of the lock out feature 12. Extracting or retracting the slide 20 at various positions relative to the face of the circuit breaker 10 provides for engagement of the pin 22 and insertion of a padlock or other detachable lock.

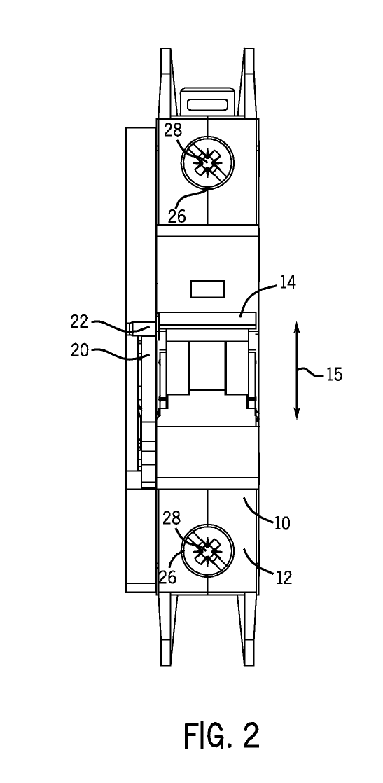

FIG. 2 depicts a front view of the circuit breaker 10, showing the housing 12, the toggle handle 14 and the lock out feature 12 mounted to the side of the circuit breaker 10. The toggle handle 14 is shown in the upward or OFF position, but may be moved along the longitudinal axis 15 to pivot the toggle handle 14 to the downward or ON position. As can be seen more clearly in FIG. 2, pin 22 is protruding from the toggle handle 14 and serves as an engagement point for slide 20 of lock out feature 12. The pin 22 may also include a shoulder portion to block the pin 22 from falling out of the assembly. Two holes 26 are depicted at the top and bottom of the circuit breaker 10 to provide for securing incoming and outgoing conductors to the circuit breaker 10 via terminal screws 28. Additionally, the circuit breaker 10 may be mounted to a plate or a DIN rail.

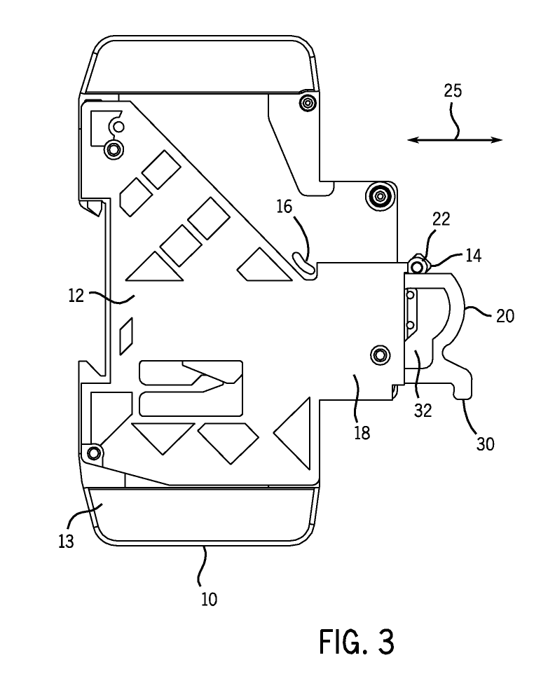

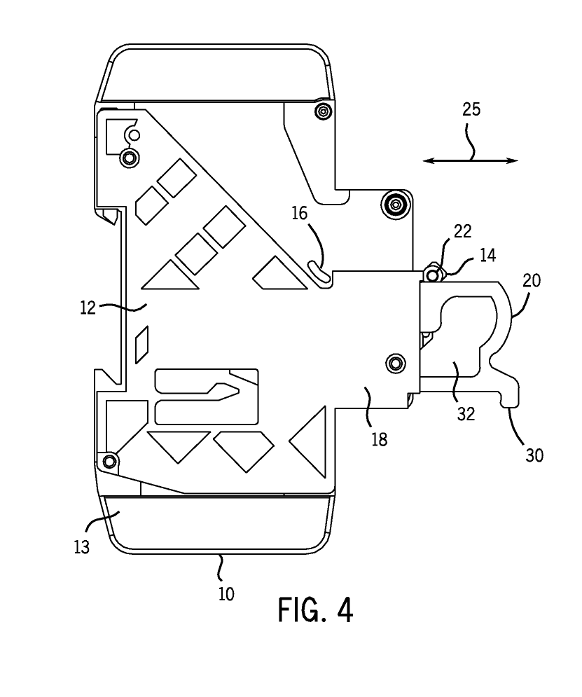

FIGS. 3 and 4 depict the slide 20 of the lock out feature 12 extracted from the body 18 along a linear direction indicated by line 25 at varying distances from the face of the circuit breaker 10. The slide 20 may include a grab handle 30 or other protrusion that provides an easy point to grab and move the slide 20. Beginning with FIG. 3, the slide 20 is shown partially extracted from the lock out feature 12. Extracting the slide 20 engages the slide 20 with the pin 22 of the toggle handle 14, thereby also engaging the toggle handle 14 and blocking movement of the toggle handle 14. In other words, the slide 20 moves linearly outward from the body 18 at a constant small gap (or no gap) relative to the pin 22, such that a surface of the slide 20 is continuously in close proximity with (or directly engaging) the pin 22 to maintain the toggle handle 14 in the OFF or upward position. In the illustrated embodiment, the top surface of the slide 20 moves along a bottom side of the pin 22. In other embodiments, the slide 20 may include an elongated slot configured to surround the pin 22 as the slide 20 moves inward and outward in the linear direction 25. With the slide 20 in this extracted position, the toggle handle 14 cannot be moved into the ON or downward position, thereby blocking operation of the circuit breaker 10 and blocking restoration of power or current flow to electrical circuits or devices. The slide 20 includes a lock receptacle 32 that may receive a padlock or other detachable lock to block the slide 20 from being retracted into the body 20 of the lock out feature 12. In the illustrated embodiment, the lock receptacle 32 has a lower inner portion and an outer upper portion to enable placement of the lock at different depths and heights.

Turning to FIG. 4, the slide 20 is shown fully extracted from the lock out feature 12. In the fully extracted position, the slide 20 continues to engage the pin 22 and block the toggle handle 14 from being moved into the downward or ON position. As shown in FIG. 4, extraction of the slide 20 exposes the entire lock receptacle 32. The size and shape of the lock receptacle 32 may advantageously accept a number of different shaft diameters of a padlock or other detachable lock, and, as will be described further below, may allow for positioning of a padlock in a row or bank of circuit breakers so as to not interfere with operation of adjacent circuit breakers.

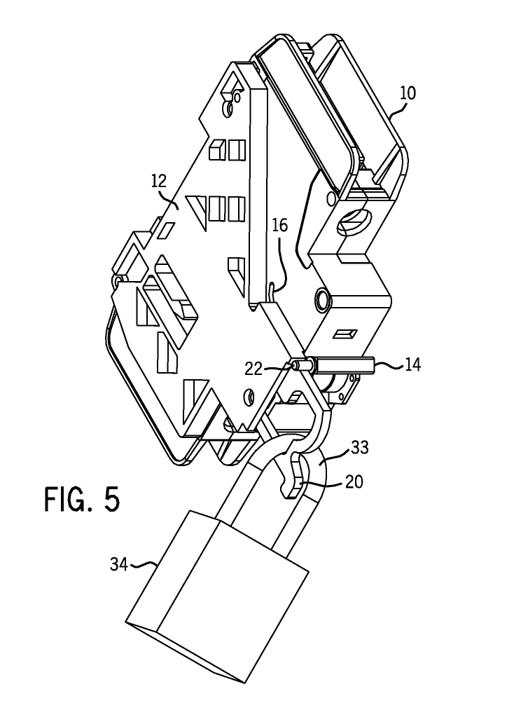

Referring now to FIG. 5, the circuit breaker 10 is shown in a locked position, e.g., the circuit breaker 10 cannot be operated and the toggle handle 14 cannot be moved to the downward or ON position. As discussed above, it may desirable to lock movement of the toggle switch 14 and operation of the circuit breaker 10 for safe adjustment, maintenance, or repair of electrical circuits or devices elsewhere in the system. The slide 20 of the lock out feature 12 is extracted far enough to enable the insertion of the shaft 33 of padlock 34. Once padlock 34 is inserted into lock receptacle 32, the slide 20 may no longer be retracted into the body 20 of the lock out feature 12. As a result, the top surface of the slide 20 continues to block movement of the toggle handle 14, thus maintaining the upward or OFF position, until the padlock 34 is removed from the receptacle 32 and the slide 20 is retracted back into the body 18.

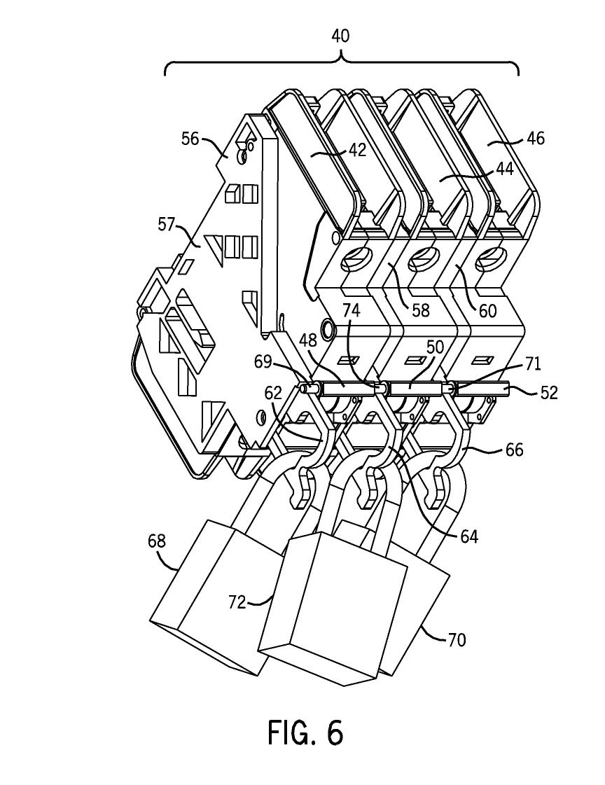

FIG. 6 depicts a perspective view of a row 40 of circuit breakers 42, 44, and 46. The row of circuit breakers may be attached to a DIN rail, a plate, or other base. Each circuit breaker 42, 44, and 46 may be configured to interrupt a different electrical circuit or conduction path through operation of the corresponding toggle handles 48, 50, and 52. Therefore, it may be desirable to individually operate each circuit breaker 42, 44 and 46 or to individually block operation of each circuit breaker 42, 44, and 46 through the use of an exemplary lock out feature. For example, it may be desirable to have the toggle handle 50 of circuit breaker 44 in an upward or OFF position, while having the toggle handle 48 of circuit breaker 42 and the toggle handle 52 of circuit breaker 46 in a downward or ON position. The exemplary lock out feature provides the ability to lock the individual toggle handles of a row of circuit breakers in an upward or OFF position, while other toggle handles in the row of circuit breakers are moveable to a downward or ON position.

Each circuit breaker 42, 44, and 46 in the row 40 has an individual lock out feature 56, 58, and 60. The lock out features 56, 58, and 60 with bodies 57 each have corresponding slides 62, 64, and 66 and operate according to the lock out feature embodiment described above in FIGS. 1-5. In the embodiment depicted in FIG. 6, the slide 62 of lock out feature 56 is shown partially extracted from body 57 to allow for insertion of padlock 68. As discussed above, pin 69 inserted into toggle handle 48 engages a top surface of the slide 62 to block movement of the toggle handle 48 out of the upward or OFF position. Inserting and locking padlock 68 blocks the slide 62 from retracting into the lock accessory 56 and, therefore, blocks the toggle handle 48 from being moved to the downward or ON position.

Similarly, the padlock 70 is inserted into the lock receptacle of slide 66 of the lock out feature 60. The pin 71 engages the top surface of the slide 66 and blocks the toggle handle 52 from being moved to the downward or ON position. Finally, the padlock 72 is inserted into the lock receptacle of slide 64 of the lock out feature 58. The pin 74 engages the top surface of the slide 64 and blocks the toggle handle 50 from being moved to the downward or ON position. In the illustrated embodiment, the slides 62, 64, and 66 are all fully extracted from their respective bodies 57, such that the padlocks 68, 70, and 72 have sufficient space to engage the lock receptacles and substantially overlap one another in front of the circuit breakers 42, 44, and 46. Specifically, the middle padlock 70 overlaps both of the surrounding padlocks 68 and 70 at a further distance from the front of the circuit breakers 42, 44, and 46.

The large lock receptacles in the slides 62, 64, and 66 and the variable extraction distance of the slides 62, 64, and 66 may enable this close proximity and overlap of the padlocks 68, 70, and 72. In certain embodiments, the adjacent slides 62, 64, and 66 may be extracted to different distances, thereby aiding in the attachment of the padlocks 68, 70, and 72 at different distances away from the respective circuit breakers 42, 44, and 46. For example, the middle slide 64 may be fully extracted while the surrounding slides 62 and 64 may be partially extracted. Similarly, in longer series of circuit breakers with lock out features, the slides and associated locks may alternate between different extraction distances. In addition, the padlocks may alternate between high and low mounting positions within the lock receptacles. Again, the slides 62, 64, and 66 advantageously enable placement of padlocks in close proximity with one another, while enabling independent lock out, access, and general operation of the circuit breakers 42, 44, and 46.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a circuit breaker, comprising
a housing;
a toggle switch coupled to the housing; and
an integral lock out coupled to the housing, wherein the integral lock out comprises a slide configured to move in a linear direction between a retracted position and an extracted position relative to the housing, and the slide is configured to block rotation of the toggle switch in the extracted position of the slide.

2. The system of claim 1, wherein the toggle switch comprises a pin configured to engage the slide as the slide moves into the extracted position.

3. The system of claim 2, wherein the pin comprises a shoulder disposed between the toggle switch and the slide.

4. The system of claim 2, wherein the pin protrudes from a side of the toggle switch in a crosswise direction relative to a rotational path of the toggle switch.

5. The system of claim 1, wherein the slide is configured to block rotation of the toggle switch in both clockwise and counterclockwise directions relative to an axis of rotation of the toggle switch when the slide is in the extracted position.

6. The system of claim 1, wherein the slide comprises a lock receptacle configured to receive a padlock in the extracted position of the slide.

7. The system of claim 6, wherein the lock receptacle is elongated generally in the linear direction of the slide.

8. The system of claim 6, wherein the lock receptacle is configured to receive the padlock at different distances away from the toggle switch.

9. The system of claim 1, comprising a motor, an actuator, an electrical device, a computer system, a network, an automation system, an industrial system, or a combination thereof, coupled to the circuit breaker.

10. A system, comprising:
a lock out, comprising:
a pin configured to couple to an actuator of an electrical device; and
a slide configured to move in a linear direction between a retracted position and an extracted position relative to the electrical device, and the slide configured to engage the pin in the extracted position of the slide.

11. The system of claim 10, wherein the slide comprises a protruding handle configured to facilitate retracting or extracting the slide.

12. The system of claim 10, wherein the pin comprises a shoulder configured to block movement of the pin in a crosswise direction relative to the linear direction of the slide.

13. The system of claim 10, wherein the lock out is configured to mount permanently to the electrical device.

14. The system of claim 10, wherein the slide is configured to mount internally and integrally within the electrical device.

15. The system of claim 10, wherein the slide is configured to block rotation of the actuator via the pin when the slide is in the extracted position.

16. The system of claim 10, wherein the slide comprises a lock receptacle configured to receive a padlock in the extracted position of the slide.

17. The system of claim 16, wherein the lock receptacle comprises an elongated slot configured to receive the padlock at different distances away from the electrical device.

18. The system of claim 10, comprising the electrical device having the lock out integrally disposed in a common housing.

19. A method, comprising:
blocking rotation of a toggle switch in response to a linear movement of a slide from a retracted position to an extracted position relative to an electrical device having the toggle switch; and
receiving a lock into a receptacle of the slide to retain the slide in the extracted position to lock out the toggle switch.

20. The method of claim 19, wherein blocking rotation comprises engaging the slide with a portion of the toggle switch as the slide moves into the extracted position.
